(19) United States
(12) Patent Application Publication
(10) Pub. No.: US 2024/0045829 A1
(43) Pub. Date: Feb. 8, 2024

(54) MULTI-DIMENSIONAL NETWORK SORTED ARRAY MERGING

(71) Applicant: Intel Corporation, Santa Clara, CA (US)

(72) Inventors: Robert Pawlowski, Beaverton, OR (US); Sriram Aananthakrishnan, Lubbock, TX (US)

(73) Assignee: Intel Corporation, Santa Clara, CA (US)

(21) Appl. No.: 18/131,143

(22) Filed: Apr. 5, 2023

(51) Int. Cl. G06F 15/173

(52) U.S. Cl. CPC G06F 15/17375

(57) ABSTRACT

Techniques for multi-dimensional network sorted array merging. A first switch of a plurality of switches of an apparatus may receive a first element of a first array and a first element of a second array. The first switch may determine that the first element of the first array is less than the first element of the second array. The first switch may cause the first element of the first array to be stored as a first element of an output array.

### STATEMENT OF GOVERNMENT RIGHTS

This invention was made with Government support under Agreement No. HR0011-17-3-0004, awarded by DARPA. The Government has certain rights in the invention.

### BACKGROUND

Merging of sorted arrays is a common operation used in computing contexts. As the number of arrays being merged increases, system performance may degrade. Furthermore, in parallel computing contexts, synchronization between cores is challenging and may introduce additional latency, which may degrade performance.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates a logic flow 900 in accordance with one embodiment.

FIG. 10 illustrates an aspect of the subject matter in accordance with one embodiment.

### DETAILED DESCRIPTION

Embodiments disclosed herein provide a full architectural approach to support sorted array merge operations in a scalable system using a network of configurable switches. More specifically, embodiments disclosed herein may define specific instructions in an Instruction Set Architecture (ISA) for various operations used to provide sorted array merges. Furthermore, embodiments disclosed herein may include hardware modifications to the compute path within each network switch, which may include providing hardware functionality to send input arrays to the switch network and receive output arrays from the switch network.

Embodiments disclosed herein may improve system performance by implementing an array merge in configurable switch hardware. The system performance improvement may increase as the number of arrays being merged increases and/or when the array sizes are large. By providing new ISA instructions and hardware management of the full merge operation, the complexity of software to implement the array merge may be reduced.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

An emerging technology that is optimized for large scale graph analytics may include the Intel® Programmable and Integrated Unified Memory Architecture (PIUMA), although examples can apply to other architectures such as the NVIDIA® Graphcore, Cray® Graph Engine, and others. PIUMA includes many multi-threaded core nodes that utilize up to 8-byte memory transactions to take advantage of fine-grained memory and network accesses. The multi-threaded core nodes may share a global address space and have powerful offload engines. The multi-threaded core nodes of PIUMA provide a hardware mechanism for scheduling work across a relatively large distributed system via, for example, merging two or more sorted arrays.

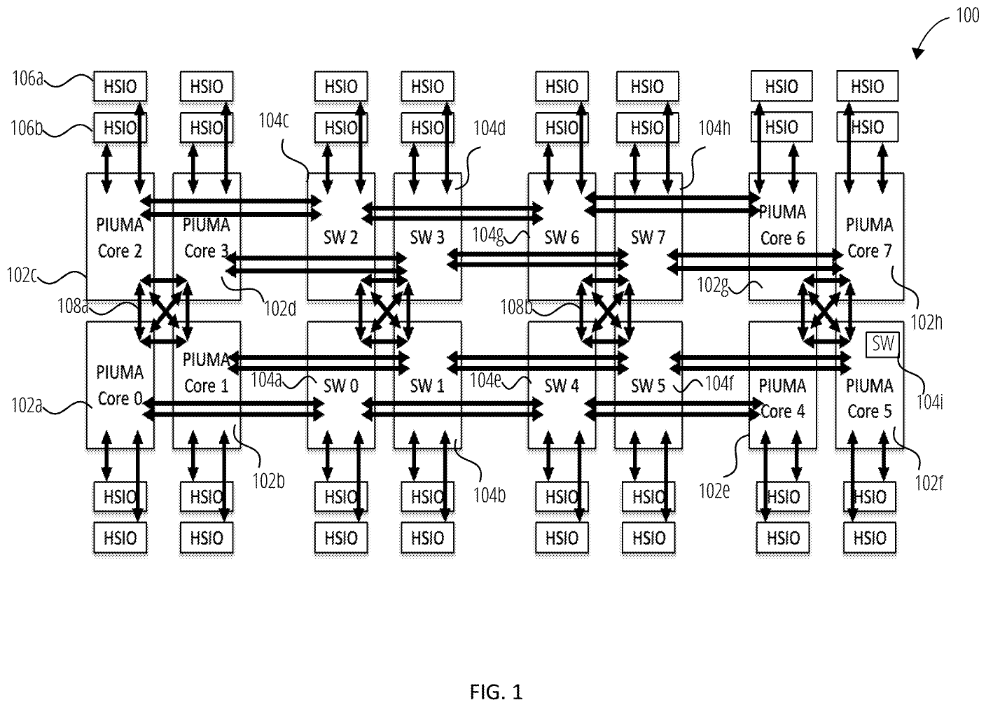

FIG. 1 illustrates an example system 100. The system 100 may be referred to as an “in-network collective subsystem” herein. According to some examples, system 100 may be elements of a PIUMA system-on-chip (SoC), die or semiconductor package that provides a scalable machine targeting sparse-graph applications. As shown, system 100 may represent a high-level diagram of a single PIUMA SoC. For these examples, system 100 may include eight multi-threaded compute cores 102a-102h, each core having a corresponding intra-die or intra-package switch (e.g., switch 108a) to allow packets into and out of a scalable system fabric. Also, compute cores 102a-102h may each separately couple to two high speed input/outputs (HSIOs) (e.g., HSIO 106a-106b - each HSIO not labeled for clarity) to allow for inter-die or inter-package connectivity across multiple PIUMA SoCs, dies, and/or semiconductor packages in a larger PIUMA system (e.g., maintained on a same or different board, same or different compute platform nodes or same or different racks). In other examples, each core 102a-102h may include one or more multi-threaded pipelines and one or more single-threaded pipelines. In one example, each of cores 102a-102h includes four multi-threaded pipelines and two single-threaded pipelines, which may support a total of 66 threads per core.

According to some examples, to support in-die or in-semiconductor package network porting to HSIOs and inter-die connectivity, system 100 includes eight switches (SW), namely switches 104a-104h having respective HSIOs (not labeled for clarity). As shown, switches 104a-104h couple with respective cores 102a-102h as illustrated by respective parallel pairs of double arrows. As shown, switches 104a-104h may include an intra-die switch (e.g., switch 108b for the die including switches 104e-104h). Furthermore, each of cores 102a-102h may include a respective switch, such as switch 104i (switches in remaining cores not pictured for clarity) corresponding to switches 104a-104h. The elements of FIG. 1, including but not limited to the cores 102a-102h, switches 104a-104i, HSIOs 106a-106b, and switches 108a-108b may be implemented in circuitry and/or a combination of circuitry and software.

In some examples, a network topology includes nodes having groupings of four cores 102a-102h or four switches 104a-104h as respective tiles. For example, a first tile may include cores 102a-102d, while a second tile may include switches 104a-104d, a third tile may include switches 104e-104h, and a fourth tile may include cores 102e-102h. A cluster of arrows shown in FIG. 1 for each of tile signify possible routes (e.g., via switch 108a, switch 108b) for an intra-die, switch-based collective operations, such as operations to merge a plurality of sorted arrays. Examples in this disclosure will describe more details below of this switch-based collective sorted array merge operation.

Beyond a single die, system configurations can scale to multitudes of nodes with a hierarchy defined as sixteen die per subnode and two subnodes per node. PIUMA network switches can include support for configurable collective communication. In some examples, a die can include one or more core tiles and one or more switch tiles. In some examples, four cores can be arranged in a tile; four switches can be arranged in a tile; four tiles can be arranged in a die; and thirty-two die can part of a node. However, other numbers of cores and switches can be part of a tile, other numbers of tiles can be part of a die, and other numbers of die can be part of a node.

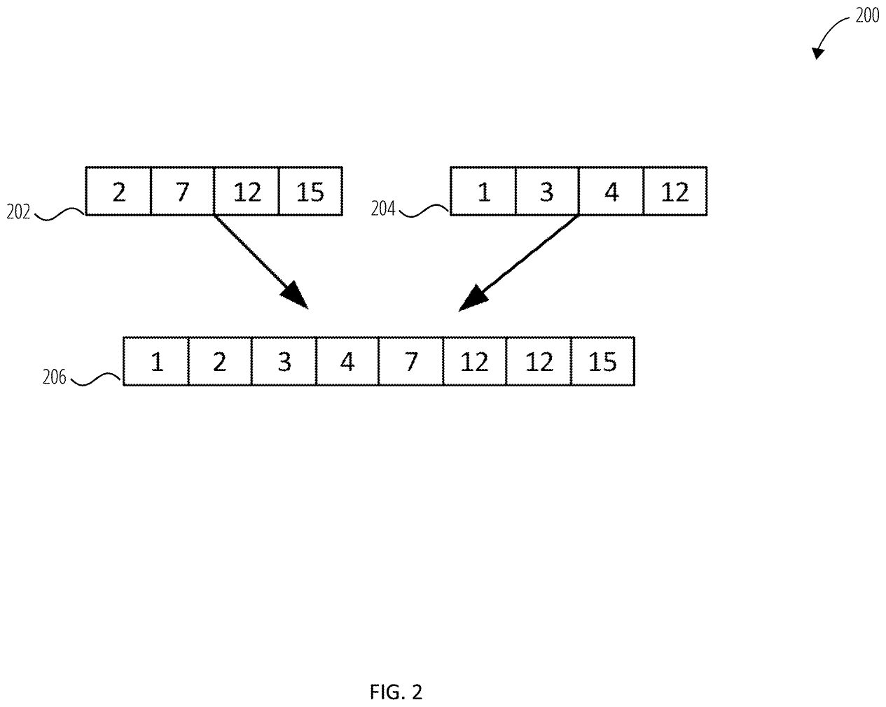

FIG. 2 is a schematic 200 illustrating an example of merging two sorted arrays. As shown, input array 202 and input array 204 each include four elements. The elements of input arrays 202, 204 are sorted according to the corresponding values, e.g., from least to greatest. The merged array 206 is an output of the merge operation. As shown, merged array 206 includes the elements of input array 202 and input array 204. Furthermore, the entries of merged array 206 are sorted, e.g., from least (or minimum) value to greatest (or maximum value). Embodiments are not limited in this context.

Merging arrays may be a common task in parallel sorting operations, JOIN operations in database management systems, and/or in graph analytics operations. For example, merging may be used to combine adjacency lists or to improve the performance of Sparse Matrix Dense Vector multiplication (SpMV) operations on the compressed sparse row (CSR) matrix format. However, implementing such merge operations may be challenging in a system such as PIUMA system 100. The system 100 may provide a full architectural approach to support sorted array merge operations as described in greater detail herein.

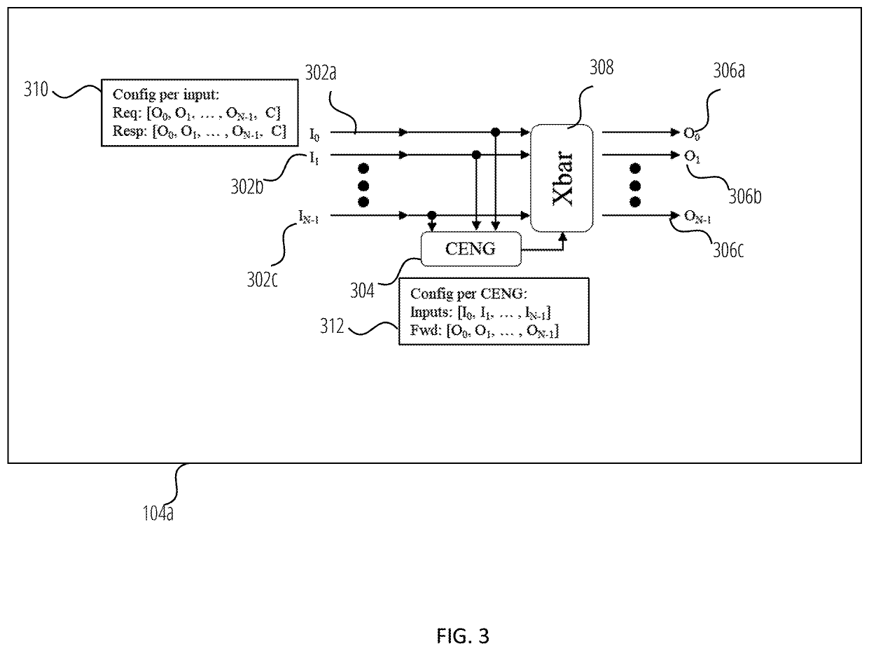

FIG. 3 illustrates components of switch 104a in greater detail, according to one example. Switch 104a is used as a reference example in FIG. 3. However, the components depicted in FIG. 3 may be included in each switch 104b-104i. Furthermore, the components depicted in FIG. 3 may be included in the respective switches of each core 102a-102h, such as switch 104i of core 102f. As shown, the switch 104a includes N ports, where N is any positive integer. For example, as shown, switch 104a may include input ports 302a-302c and output ports 306a-306c. Furthermore, the switch 104a includes a collective engine (CENG) 304, a crossbar 308, and a plurality of registers including configuration registers 310 and configuration registers 312. The crossbar 308 may be an interconnect that couples input ports 302a-302c to output ports 306a-306c.

The configuration registers 310 include, for each input port 302a-302c, a request (Req) configuration register for the forward path of a merge operation and a response (Resp) configuration register for the reverse path of the merge operation. During the forward path of a merge operation, value comparison operations are performed to determine the minimum (or least) value among two or more values. The two or more values may be associated with two or more arrays such as input arrays 202, 204. During the reverse path of the merge operation, the final value is returned to the core assigned as responsible for receiving the final output array. For example, software may specify one of cores 102a-102h as the core responsible for receiving the final output array. Embodiments are not limited in this context.

More specifically, the request configuration registers 310 include a bit vector which represents the output port that each input port is forwarded to. For example, the request configuration registers 310 for input port 302a may specify that the input port 302a is forwarded to output port 306a. Furthermore, the request configuration registers 310 include a bit (labeled “C”) in FIG. 3 to indicate if the input port is providing its value to the collective engine 304 for computation (e.g., a minimum value computation) for the merge operation. Therefore, the collective engine 304 includes circuitry to determine a minimum value (based on two or more input values). Although a minimum value is used as a reference example, in some embodiments, the circuitry of the collective engine 304 may determine the least value among two or more input values. In the event two values being compared are equal, the collective engine 304 may include circuitry to select one of the values as the minimum value and reuse the unselected value.

The configuration registers 312 define the configuration for the collective engine 304. As shown, the configuration registers 312 include input registers that define which of the input ports 302a-302c will provide values for a minimum (or least) value computation to be performed by the collective engine 304. The configuration registers 312 further include forward (“Fwd”) registers that define one or ore more output ports 306a that the output of the collective engine 304 (e.g., a minimum value among two or more values) is to be forwarded through.

As stated, embodiments disclosed herein modify the collective engine 304 of the switches 104a-104i to include circuitry to compute minimum (or least) values among two or more input values. Further still, the collective engine 304 may include circuitry to retain the non-minimum value for use during the next iteration of the merge operation. For example, if the collective engine 304 determines that “1” is the minimum value among the values “1” and “4”, the value “4” is retained by the collective engine 304 for use in the next minimum value computation. Furthermore, the collective engine 304 may include circuitry to select valid inputs when one of the input arrays has no further elements to contribute to the merge operation. For example, when merging arrays A and B, and array A has no remaining elements, the collective engine 304 may select the element from array B as the minimum value for each remaining iteration.

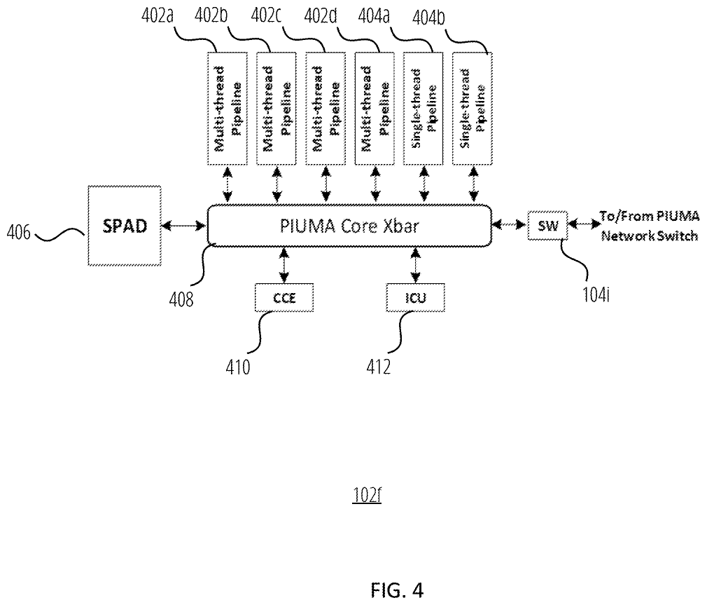

FIG. 4 illustrates components of an example PIUMA core, such as core 102f, in greater detail. As shown, the core 102f includes switch 104i, multi-threaded pipelines 402a-402d, single-threaded pipelines 404a-404b, a scratchpad 406 memory (e.g., to store data during computations), a core collective engine 410, and an interrupt controller unit 412 coupled via crossbar switch 408.

To facilitate sorted array merge operations, the system 100 may define ISA extensions (e.g., ISA instructions) and include modifications to the cores 102a-102h to initiate a merge operation. Generally, the multi-threaded pipelines 402a-402d and/or the single-threaded pipelines 404a-404b may issue an instruction defined by the ISA to the core collective engine 410 to initiate the merge operation. The instruction may be referred to herein as a “merge.init” instruction. Doing so may cause the core collective engine 410 to read each element of an input array based on the base address of the input array specified in the merge.init instruction. The core collective engine 410 may then issue requests into the network of the system 100.

More generally, when initiating a merge operation for a plurality of arrays, software may define the number of arrays to be merged (e.g., a count of the plurality of arrays). The software may assign respective ones of the plurality of arrays to respective ones of the cores 102a-102h. The respective cores 102a-102h may issue a respective merge.init instruction for the array assigned to the core. By executing the merge.init instruction, the core 102a-102h causes the values of the respective array to be fetched for processing as specified by a merge tree associated with the merge operation. For example, if eight arrays are being merged, an array may be assigned to a respective core 102a-102h. The respective core 102a-102h may issue a merge.init instruction for the array, for a total of eight merge.init instructions.

In some embodiments, a parallel for loop may be implemented to assign an array to a core for processing. Generally, the for loop may iterate over the plurality of arrays, with each iteration assigning an array to a different core. Within the loop iteration, the input array for each core is built locally. At the end of the loop iteration the merge occurs and the core pushes its array into the network collective subsystem for processing.

Furthermore, embodiments disclosed herein define ISA extensions (e.g. ISA instructions) and include modifications to the cores 102a-102h for receiving the merged output array and writing the merged output array to memory. Such an instruction may be referred to as a “merge.poll” instruction or a “merge.wait” operation. In some embodiments, the system 100 may further alert requesting software that the merge operation has completed.

Further still, by defining an in-network tree, performance may of parallel merge operations over a variable number of input arrays may be improved.

Table I below includes detail describing example ISA instructions to support merge operations, including the instruction name, instruction arguments, and descriptions of each argument.

TABLE I

| Instruction | Arguments | Argument Descriptions |
|---|---|---|
| merge.init | r1, r2, r3, size | r1 = Merge tree ID; r2 = Input Array |
| | | Base Address; r3 = Number of elements |
| | | (of size) in input array |
| merge.poll | r1, r2, r3 | r1 = if operation is complete, return the |
| | | number of elements in the output |
| | | array, else return 0; r2 = if operation is |
| | | complete, return base address of |
| | | output array, else return 0; r3 = merge |
| | | tree ID; |
| merge.wait | r1, r2, r3 | r1 = return the number of elements in |
| | | the output array; r2 = return base |
| | | address of output array; r3 = merge tree |
| | | ID |

As shown, the merge.init instructions includes arguments for a merge tree identifier (ID), an input array base memory address, and the number of elements of a specified size in the input array. Generally, a merge.init instruction is issued by each thread that is contributing an input array to the merge operation. When a PIUMA thread executes a merge.init instruction (e.g., in one of the pipelines 402 or 404), the thread will ship the full instruction to the core collective engine 410 of the associated core (e.g., core 102f in the example depicted in FIG. 4) for processing. As stated, the merge.init instruction includes inputs for the base address of the input array, the size of each array element, and the total number of elements. Because multiple connectivity configurations are supported, the instruction includes a value specifying the configured network tree ID.

The merge.poll instruction may be issued by one thread (e.g., in one of the pipelines 402 or 404) in the core that is to receive the final output array of the merge operation (e.g., the final merged output). The merge.poll instruction is non-blocking to the thread. As shown in Table I, the arguments to merge.poll include r1, r2, and r3. Generally, the merge.poll instruction returns a 0 in the r1 field is the merge operation is not complete. If the merge operation is complete, the number of elements in the output array are returned in the r1 field. If the merge operation is complete the base address of the output array (and/or the number of elements of the output array) are returned in the r2 field. Argument r3 corresponds to the identifier of the merge tree processing the merge operation.

The merge.wait instruction may be issued by one thread (e.g., in one of the pipelines 402 or 404) in the core that is to receive the final output array of the merge operation. The merge.wait instruction may function similarly to merge.poll, except that it is blocking to the issuing thread, e.g., it will not allow forward progress of the issuing thread until it returns a valid base address and element count of the output array. If the merge operation is not complete when the instruction is issued, it will wait until the instruction is complete. As shown in table I, the arguments for merge.wait include r1, r2, and r3. Generally, r1 returns the number of elements in the output array, r2 returns the base address of the output array, and r3 returns the identifier of the merge tree processing the merge operation.

The merge.init, merge.poll, and merge.wait instructions are examples of ISA instructions. However, embodiments are not limited in these contexts, as other ISA instructions may be used. For example, a subset of the bits allocated to the merge tree ID may be specified. As another example, an end address of the input array may be specified instead of the number of input elements in a merge.init instruction. Similarly, the merge.poll and merge.wait instructions may return the end address of the output array instead of the number of elements in the output array. As another example, an ISA instruction may specify to merge two or more arrays (e.g., “merge (array[0], array[1])), where the instruction specifies at least a base address of the respective arrays to be merged. As another example, an ISA instruction may specify to merge a number of arrays (e.g., merge(number_of_arrays)), where the instruction specifies at least a base address of the respective arrays to be merged.

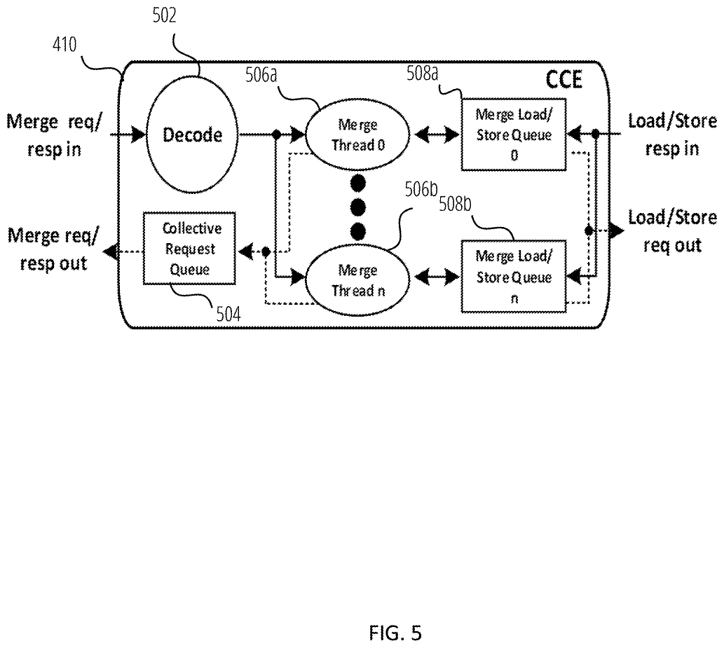

FIG. 5 shows the components of the core collective engine 410 of the cores 102a-102h in greater detail, according to one example. As shown, the core collective engine 410 includes a decoder 502, a collective request queue 504, one or more merge threads 506a-506b (where each merge thread is associated with a respective identifier), and one or more load/store queues 508a-508, where each load/store queue 508a is associated with a respective one of the merge threads 506a-506b.

Generally, merge instructions (e.g., merge.init, merge.poll, and/or merge.wait instructions) may be received via the crossbar 408. The decoder 502 may decode the merge instruction and provide the decoded instruction to one of the merge threads 506a-506b based on the identifier in the instruction. Therefore, each merge thread 506a-506b may manage one or more sorted array merge operations, each operation having an associated unique ID. The load/store queue 508a may be a queue for memory requests (e.g., to read each element of the input array and/or to write each element of the output array). For example, when an element of the input array is read from memory, the element may be stored in the load/store queue 508a-508b of the associated merge thread 506a-506b. Similarly, when the merge thread receives an output value to be written to the output array, the output value may be stored in the load/store queue 508a-506b of the associated merge thread 506a-506b before being written to memory.

The collective request queue 504 is a shared queue for sending input array element requests to the in-switch collective subsystem (e.g., sending input array elements to other cores 102a-102h and/or other switches 104a-104i to be used in minimum value computations). In some embodiments, backpressure may occur (e.g., when one element of an array is not the minimum value in a comparison operation, that element is reused in the next comparison operation, thereby creating backpressure). Therefore, the collective request queue 504 may store elements of the array in the event of backpressure (e.g., to store a next element in the array while the previous element is reused in the next comparison operation).

As stated, merge.init instructions may be issued from one or more of multi-threaded pipelines 402a-402c and/or single-threaded pipelines 404a-404b. When such an ISA-defined merge.init instruction is issued, the instruction is sent to the core collective engine 410 of the associated core 102a-102h. The core collective engine 410 may then assign the merge.init instruction to the corresponding merge thread 506a-506b associated with the ID specified in the merge.init instruction. The merge thread 506a-506b then performs the following operations based on the base address and number of elements specified in the merge.init instruction. Starting with the base address as a target address, which may be a 64-bit address, the merge thread 506a-506b makes load requests for elements of the size specified in the instruction to the target memory where the input array is stored. Doing so causes a request for each element of the array to be returned from memory. For each element, the target address is the address of the previous element plus the size of one element. Therefore, for the second element in the array, the target address is the base address plus the size of one element.

As each array element is returned responsive to the load requests, the value of the array element is stored in the collective request queue 504. The value is the outputted to the collective subsystem in one or more request packets, or messages (e.g., sent to other cores 102a-102h and/or other switches 104a-104i to be used in minimum value computations). Doing so may cause each element of the input array received from memory to be pushed to the collective subsystem for minimum value computations. A request packet may include the following information depicted in Table II:

TABLE II
Packet Field

| Name | Description | Width | |
|---|---|---|---|
| Tree ID | ID of the network collective tree to | 3 | bits |
| | use. The network collectives support | | |
| | multiple concurrent trees. | | |
| Data Size | The size of the data field for the | 2 | bits |
| | operation. (2′b00 = 1B, 2′b01 = 2B, | | |
| | 2′b10 = 4B, 2′b11 = 8B) | | |
| Data | Data to be used for the merge | 64 | bits |
| | operation. | | |
| Collective Type | Specify type of operation to execute at | 2 | bits |
| | the switch collective engine 304. | | |
| | (2′b00 = barrier, 2′b01 = reduction, | | |
| | 2′b10 = multicast, 2′b11 = merge) | | |
| Array End | Indicates that all elements from this | 1 | bit |
| | input array have been sent. | | |

As shown, a request packet may include the ID of the network collective tree, a size of the data (e.g., the size of an element of the input array), the data to be used in the merge operation (e.g., the value of the element of the input array), the type of operation to be performed at the collective engine 304 of a switch 104a-104i, and a bit indicating whether the packet includes the final element of the input array.

For each element of the input array, the core collective engine 410 keeps track of the count of load requests made to memory and a count of returned loads sent to the in-network collective subsystem. Once all elements of the input array have been sent via the collective request queue 504, the core collective engine 410 may transmit a final request (e.g., to the receiving switch 104a-104i and/or core 102a-102h) indicating that the input array has reached the end (e.g., no additional elements of the input array remain). This may assist the collective engine 304 of the switch 104a-104i to determine to bypass any further input received from the core collective engine 410 for the remainder of the corresponding operation. For example, the final request may have the “array end” bit set to 1 to indicate no more elements of the input array remain for the corresponding tree ID.

For each sorted array merge operation, the core collective engine 410 of one core 102a-102h is specified to receive all elements of the final output array, which may be predetermined (e.g., defined by software). As minimum elements are received in order from the collective engine 304 of the switch 104a-104i, these elements are stored in order in a memory location. The memory location may be predetermined, e.g., defined by software. The core collective engine 410 receiving the final output array may be initialized via a set of configuration registers (e.g., the configuration registers 312) that indicate the size of the expected final output array to be received. The writing of the configuration to these registers may be a precondition to the collective engine 304 successfully accepting final output array packets from the in-network collective subsystem. The configuration registers may be defined in Table III below:

TABLE III

| MSR Name | Description | Width | |
|---|---|---|---|
| Output Base | Base address of the output array. | 64 | bits |
| Address | | | |
| Output Element | Total number of elements to be | 32 | bits |
| Count | written to the output array | | |
| Size | Output array element size | 2 | bits |
| Enable | When asserted, all other MSRs have | 1 | bit |
| | been configured and the CCE is ready | | |
| | to receive data | | |

As shown, the configuration registers may include, for an associated tree ID, a base address of the output array, the total number of elements to be written to the output array, the size of an element of the output array, and an enable bit. The enable bit is asserted once the other register values are written, which allows the collective engine 304 to accept packets from the in-network collective subsystem.

The input arrays may then be fed into the in-network collective subsystem, where the merge is processed by the switches 104a-104i and/or the cores 102a-102h (e.g., using minimum value computations between two or more input array elements). Generally, output array elements are received by the core collective engine 410 in order. As each element is received, the core collective engine 410 generates a store request of the element's data value to the memory location of the output array. Doing so causes the first element to be stored at the base address specified in the configuration registers, while each successive element's target address is the previous element's address plus the size of one output array element. Therefore, for the second element in the output array, the target address is the base address plus the size of one element of the output array.

The core collective engine 410 may maintain a count of the number of output array elements received. Once the full output array is written to memory, the core collective engine 410 considers the operation to be completed. The core collective engine 410 may notify the requesting software via push (e.g., an interrupt) or poll operation. For example, in a push embodiment, the core collective engine 410 may cause the interrupt controller unit 412 to generate an interrupt that will launch on one of the single-threaded pipelines 404a-404b. This interrupt routine may inspect the status of the merge operation by inspecting the status registers of the core collective engine 410 associated with the ID (e.g., to determine if the full output array has been written to memory). In the poll embodiment, one of the threads (e.g., multi-threaded pipelines 402a-402d and/or single-threaded pipelines 404a-404b) of the core associated with the final output array may poll the merge threads 506a-506b at periodic intervals using a merge.poll instruction. If successful, the core collective engine 410 may return the base address of the final output array and the element count of the final output array to the thread that issued the merge.poll instruction.

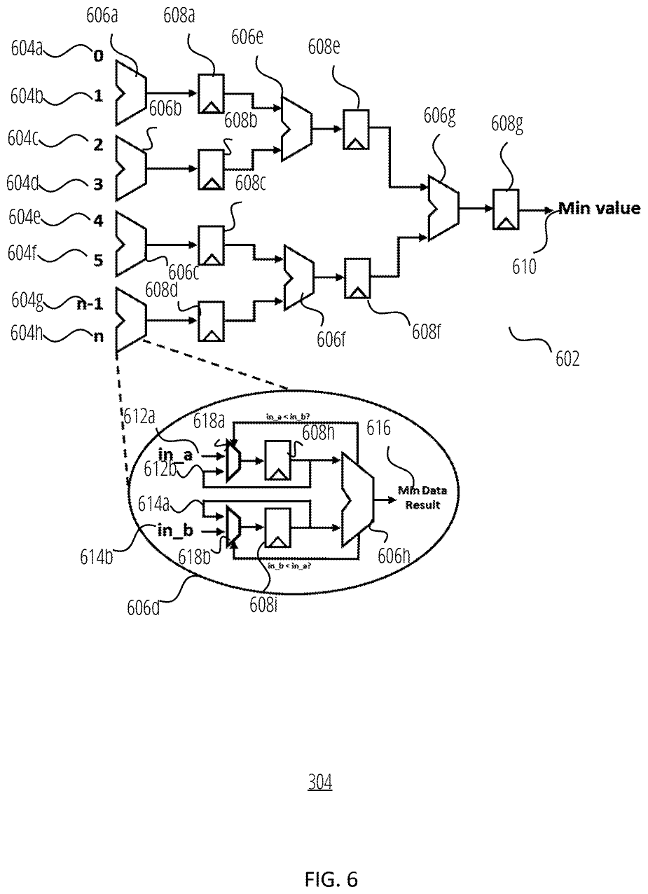

FIG. 6 illustrates the components of the collective engine 304 in greater detail, according to one example. As stated, the collective engine 304 includes circuitry to determine the minimum (or least) value among two or more input array elements. Furthermore, the collective engine 304 includes circuitry to reuse an element that was not the minimum (or least) value in one iteration in the next iteration. Further still, the collective engine 304 includes circuitry to select a valid input as the minimum value when one input array has no remaining input elements to contribute to the minimum value computations.

As shown, the configuration registers 312 of the collective engine 304 may define a tree 602 associated with a merge operation (which may be identified via a unique identifier). The tree 602 defines a full compute path within the collective engine 304, which is a tree of execution stages. The depth of the tree 602 may be determined based on the number of input ports 302a-302c that feed into the collective engine 304 of the switch 104a-104h. For example, if there are eight input ports participating in the merge operation, the tree 602 may include three compare stages and seven total execution units (e.g., arithmetic logic units (ALUs) and/or floating point units (FPUs)). Tree 602 reflects an embodiment where eight input ports participate in the merge operation, depicted as input ports 604a-604h, each of which may correspond to the input ports 302a-302c of FIG. 3. Therefore, tree 602 includes seven execution units 606a-606g. The output of an execution unit 606a-606g is fed to a flop 608a-608g, which allows values to be reused when not selected as the minimum value in an iteration. The minimum value from one iteration is then passed to the next execution unit for further minimum value computations, until a final minimum value output 610 is returned. The process repeats until all input array elements have been returned as a respective minimum value output 610.

In some embodiments, a data-flow approach is applied for processing a merge operation. For example, when both inputs of a respective logic unit the receive valid data, a minimum value computation occurs. For example, when input ports 604a and 604b receive valid data (e.g., array elements), execution unit 606a may determine the minimum value. This data-flow approach permeates through the tree 602 and the system 100. In some embodiments, the data-flow approach includes passing of “valid” bits with the elements of array data to indicate the elements include valid data. Furthermore, the data-flow approach includes inserting flops (e.g., flops 608a-608i) on the data paths. If input from one array arrives before input from another array, the comparison operation may wait for the input from the another array. This may cause backpressure through the input ports of the switch, to the core collective engine 410, and back to the collective engine 304. The collective request queue 504 may store backpressured array elements to prevent blocking. Therefore, array input elements can arrive at any time and in any order and the final result will always remain the same.

FIG. 6 further depicts a logical view of the execution unit 606d in greater detail. As shown, execution unit 606d includes two logic units 618a-618b. Each logic unit 618a, 618b receives two elements of input, namely inputs 612a-612b and inputs 614a-614b, respectively. However, logical logic units 618a-618b are configured to reuse values from a previous minimum value computation. For example, if input value input 612a is the minimum selected from input 612a and 614a by execution unit 606h, then input 614a may be reused in the next minimum value computation iteration.

As shown, flop 608h and 608i flop the inputs preceding the minimum value comparison performed by execution unit 606h. The result of the comparison operation performed by execution unit 606h determines which input value is to be held for the next comparison operation. If the input value remains the same for the next comparison operation, the input into the execution stage for execution unit 606d is backpressured. In such an example, the collective request queue 504 of the core 102a-102h providing the input array elements may hold one or more array elements to alleviate the backpressure.

As stated, as part of a merge operation, an input array element may have no further elements to be processed. In such embodiments, the core collective engine 410 may send an empty packet with an indication that the input array has been exhausted (e.g., by setting the array end bit depicted in Table II). When the collective engine 304 receives this packet on an input port, the collective engine 304 only propagates valid input data values through the tree 602. For example, if input array A has no more elements for a merge with input array B, the collective engine 304 propagates elements from input array B (and not the ports associated with input array A) through the tree 602. Once both inputs to an execution unit 606a-606h receive array end packets indicating the associated input array has been exhausted (e.g., via a packet asserting the array end bit depicted in Table II), the input state of the execution unit 606a-606h is reset. The array end packets may be propagated through the tree 602 to the output of the collective engine 304. Doing so causes the array end packets to be sent to the collective engine 304 of other switches 104a-104h (and/or the collective engine 304 of switches in cores 102a-102h, such as switch 104i of core 102f) involved in the merge operation until all input arrays have issued array end packets to the associated collective engine 304. At this point, all execution units 606a-606h involved in the array merge operation may reset their inputs and the in-network collective subsystem is ready for the next array merge operation.

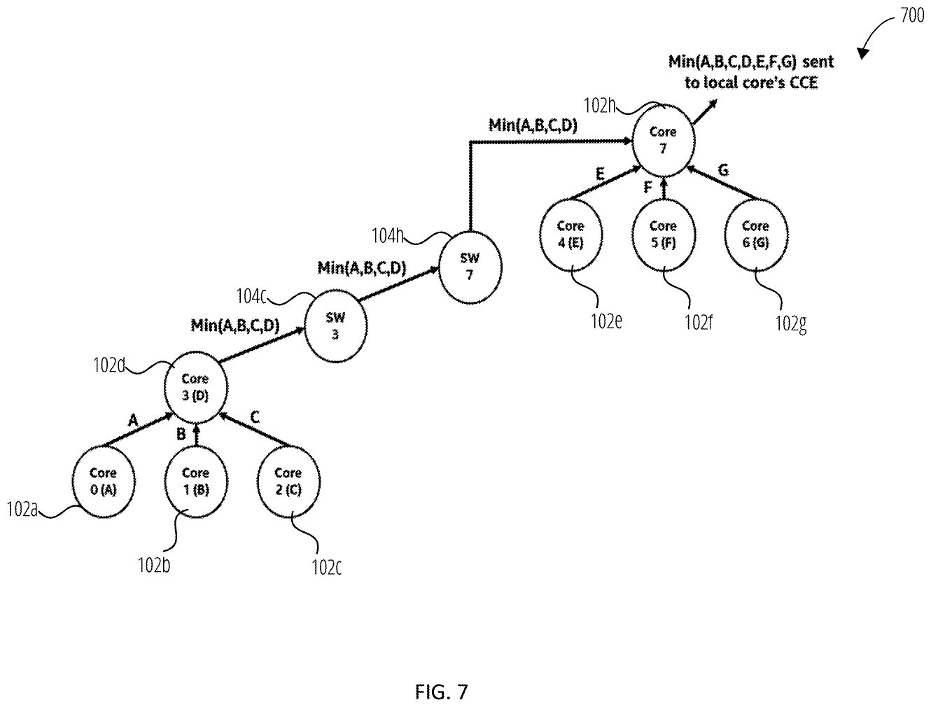

FIG. 7 illustrates an example topology 700 for an example sorted array merge operation between cores 102a-102h of a single PIUMA die. The topology 700 may be based on a configuration defined in Table IV below.

TABLE IV

| PORT | DESCRIPTION | NOTES |
|---|---|---|
| 0 | HSIO port 0 | Not used in example |
| 1 | HSIO port 1 | Not used in example |
| 2 | Intra-tile X-axis (for switch | Notated as X in FIG. 7 |
| | 108a or switch 108b) | |
| 3 | Intra-tile Y-axis (for switch | Notated as Y in FIG. 7 |
| | 108a or switch 108b) | |
| 4 | Intra-tile diagonal (for | Notated as D in FIG. 7 |
| | switch 108a or switch 108b) | |
| 5 | Inter-tile positive X-axis port | Notated as Sk0+ in |
| | 0 (for switch 108a or switch | FIG. 7 |
| | 108b) | |
| 6 | Inter-tile negative X-axis | Notated as Sk0− in |
| | port 0 (for switch 108a or | FIG. 7 |
| | switch 108b) | |
| 7 | Local Core | Notated as L in FIG. 7 |
| 8 | Inter-tile positive X-axis | Not used in example |
| | port 1 | |
| 9 | Inter-tile negative X-axis | Not used in example |
| | port 1 | |
| 10 | Switch Collective Engine | Not used in example |

As shown, Table IV includes port numbering to correspond to the ordering in the bit vectors for configuring a tree such as tree 602 or the topology 700. Table IV uses the term “tile” to reefer to a localized group of four compute cores 102a-102h and/or a group of four switches 104a-104h.

In FIG. 7, seven of the cores contribute input arrays for the array merge operation while one core receives the final merged output array. For example, as shown, cores 102a-102g contribute input array values A-G, respectively, while core 102h receives the final merged output. In FIG. 7, the collective engines 304 of switches (corresponding to switches 104a-104i) in cores 102d and 102h execute the minimum value comparison operations. For example, the collective engine 304 of the switch of core 102d determines the minimum values from the values contributed by cores 102a-102c. Similarly, the collective engine 304 of the switch of core 102h compares the values of inputs provided by core 102d (e.g., the minimum value of inputs from cores 102a-102d) and cores 102e-102g. In the topology 700, core 102d passes its result (e.g., the minimum value from arrays A-D) over the peripheral switches 104c and 104h, where no computation operations occur. The final minimum value outputted by the collective engine 304 of the switch of core 102h is provided to the core collective engine 410 of core 102h for writing to a memory address associated with the final output array. This process may repeat until all input array elements have been processed and outputted to the final output array, which is sorted according to the values of all input arrays (e.g., from least to greatest).

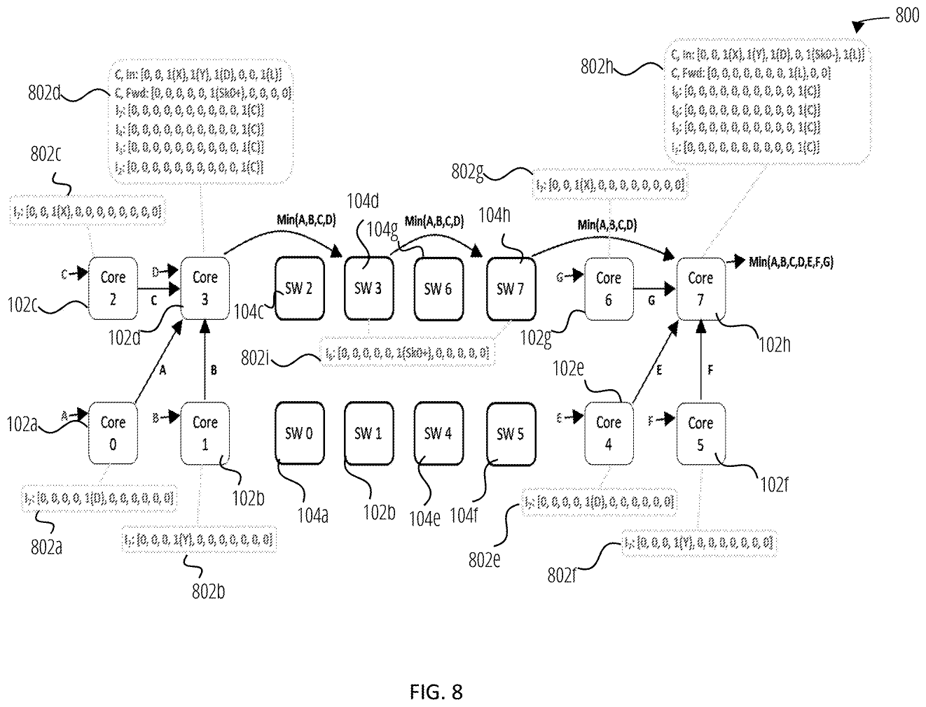

FIG. 8 is a schematic 800 illustrating example configuration values for each switch on a PIUMA die. Therefore, the configuration depicted in FIG. 8 may include configuration for one or more of switches 104a-104h as well as switches within each core 102a-102h (e.g., switch 104i and remaining switches not pictured in FIG. 1 for the sake of clarity). As shown, FIG. 8 includes configuration 802a-802h, each of which may correspond to the data stored in configuration registers 310 and/or configuration registers 312 depicted in FIG. 3. For example, configuration 802a-802h correspond to the configuration for the switches within cores 102a-102h, respectively. Similarly, configuration 802i may be the configuration for switches 104d and 104h.

Generally, when the collective engine 304 of a switch of one of cores 102a-102c has a message to be multi-casted, the “I₇” configuration register (in configuration 802a-802c) indicates that the collective engine 304 of the respective core switch will send the message to core 102d. Similarly, when the collective engine 304 of a switch of one of cores 102e-102g has a message to be multi-casted, the “I₇” configuration register (in configuration 802e-802g) indicates that the collective engine 304 of the respective core switch will send the message to core 102h.

When core 102d receives messages from cores 102a-102c, the “C,in” register of configuration 802d indicates that these inputs are passed to the collective engine 304 of the switch of core 102d. Similarly, the “C,Fwd” register in configuration 802d indicates that the output (e.g., a minimum value) will be forwarded to the corresponding switch in the neighbor tile (e.g., switch 104d) via the “Sk0+” port. The minimum value provided by core 102d passes through switch 104d and switch 104h before being provided to core 102h. Therefore, the configuration 802i is the same for switches 104d, 104h.

As shown in FIG. 8, core 102h receives inputs from the inter-tile left skip port “Sk0−” based on the configuration 802 and the three intra-tile ports (e.g., from cores 102e-102g). Core 102h provides the received inputs to the collective engine 304 of the switch of core 102h, which determines a minimum value among the inputs. Based on the configuration 802h, the determined minimum value is outputted via the local port of the switch of core 102h, which provides the minimum value to the collective engine 304 of core 102h. Doing so allows the collective engine 304 to write the minimum value as the next element of the output array.

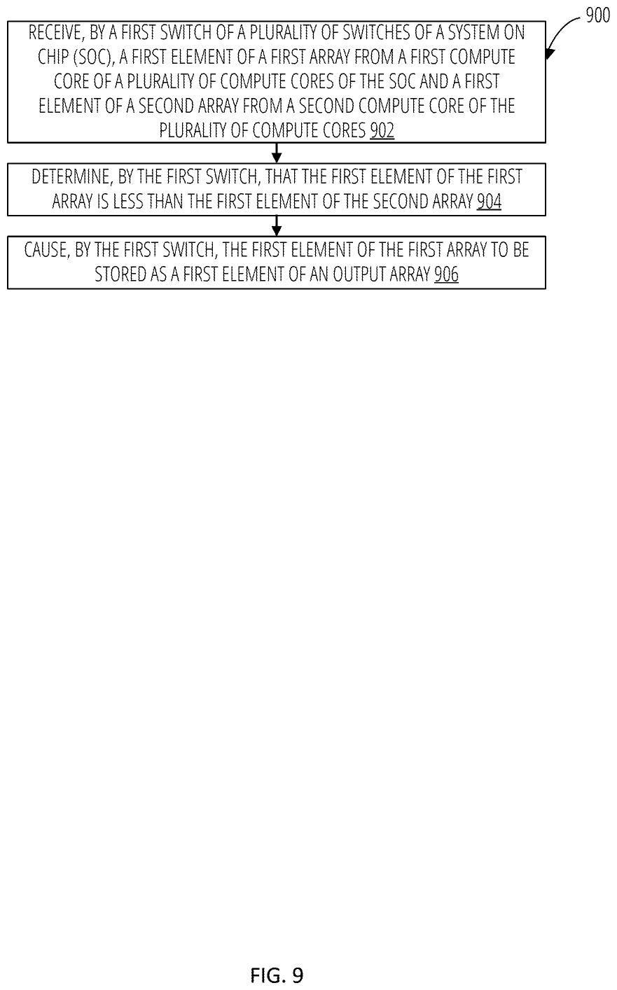

FIG. 9 illustrates a logic flow 900. Logic flow 900 may be representative of some or all of the operations for multi-dimensional network sorted array merging. Embodiments are not limited in this context.

In block 902, logic flow 900 receives, by a first switch of a plurality of switches of a system on chip (SoC), a first element of a first array from a first compute core of a plurality of compute cores of the SoC and a first element of a second array from a second compute core of the plurality of compute cores. In block 904, logic flow 900 determines, by the first switch, that the first element of the first array is less than the first element of the second array. In block 906, logic flow 900 causes, by the first switch, the first element of the first array to be stored as a first element of an output array.

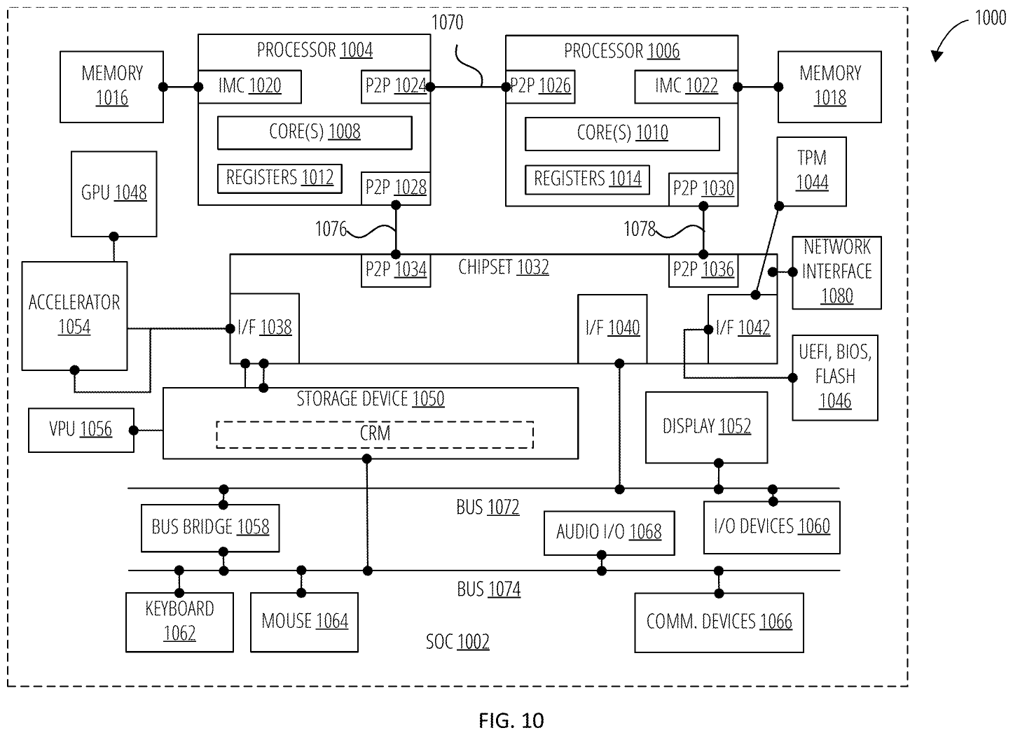

FIG. 10 illustrates an embodiment of a system 1000. System 1000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 1000 may have a single processor with one core or more than one processor. Note that the term “processor” refers to a processor with a single core or a processor package with multiple processor cores. In at least one embodiment, the computing system 1000 is representative of the components of the system 100. More generally, the computing system 1000 is configured to implement all logic, systems, logic flows, methods, apparatuses, and functionality described herein with reference to FIGS. 1-9.

As used in this application, the terms “system” and “component” and “module” are intended to refer to a computer-related entity, either hardware, a combination of hardware and software, software, or software in execution, examples of which are provided by the exemplary system 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 10, system 1000 comprises a system-on-chip (SoC) 1002 for mounting platform components. System-on-chip (SoC) 1002 is a point-to-point (P2P) interconnect platform that includes a first processor 1004 and a second processor 1006 coupled via a point-to-point interconnect 1070 such as an Ultra Path Interconnect (UPI). In other embodiments, the system 1000 may be of another bus architecture, such as a multi-drop bus. Furthermore, each of processor 1004 and processor 1006 may be processor packages with multiple processor cores including core(s) 1008 and core(s) 1010, respectively. While the system 1000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to a motherboard with certain components mounted such as the processor 1004 and chipset 1032. Some platforms may include additional components and some platforms may only include sockets to mount the processors and/or the chipset. Furthermore, some platforms may not have sockets (e.g. SoC, or the like). Although depicted as a SoC 1002, one or more of the components of the SoC 1002 may also be included in a single die package, a multi-chip module (MCM), a multi-die package, a chiplet, a bridge, and/or an interposer. Therefore, embodiments are not limited to a SoC.

The processor 1004 and processor 1006 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1004 and/or processor 1006. Additionally, the processor 1004 need not be identical to processor 1006.

Processor 1004 includes an integrated memory controller (IMC) 1020 and point-to-point (P2P) interface 1024 and P2P interface 1028. Similarly, the processor 1006 includes an IMC 1022 as well as P2P interface 1026 and P2P interface 1030. IMC 1020 and IMC 1022 couple the processor 1004 and processor 1006, respectively, to respective memories (e.g., memory 1016 and memory 1018). Memory 1016 and memory 1018 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 1016 and the memory 1018 locally attach to the respective processors (e.g., processor 1004 and processor 1006). In other embodiments, the main memory may couple with the processors via a bus and shared memory hub. Processor 1004 includes registers 1012 and processor 1006 includes registers 1014.

System 1000 includes chipset 1032 coupled to processor 1004 and processor 1006. Furthermore, chipset 1032 can be coupled to storage device 1050, for example, via an interface (I/F) 1038. The I/F 1038 may be, for example, a Peripheral Component Interconnect-enhanced (PCIe) interface, a Compute Express Link® (CXL) interface, or a Universal Chiplet Interconnect Express (UCIe) interface. Storage device 1050 can store instructions executable by circuitry of system 1000 (e.g., processor 1004, processor 1006, GPU 1048, accelerator 1054, vision processing unit 1056, or the like). For example, storage device 1050 can store instructions for a sorted array merge operation, or the like.

Processor 1004 couples to the chipset 1032 via P2P interface 1028 and P2P 1034 while processor 1006 couples to the chipset 1032 via P2P interface 1030 and P2P 1036. Direct media interface (DMI) 1076 and DMI 1078 may couple the P2P interface 1028 and the P2P 1034 and the P2P interface 1030 and P2P 1036, respectively. DMI 1076 and DMI 1078 may be a high-speed interconnect that facilitates, e.g., eight Giga Transfers per second (GT/s) such as DMI 3.0. In other embodiments, the processor 1004 and processor 1006 may interconnect via a bus.

The chipset 1032 may comprise a controller hub such as a platform controller hub (PCH). The chipset 1032 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1032 may comprise more than one controller hub such as a chipset with a memory controller hub, a graphics controller hub, and an input/output (I/O) controller hub.

In the depicted example, chipset 1032 couples with a trusted platform module (TPM) 1044 and UEFI, BIOS, FLASH circuitry 1046 via I/F 1042. The TPM 1044 is a dedicated microcontroller designed to secure hardware by integrating cryptographic keys into devices. The UEFI, BIOS, FLASH circuitry 1046 may provide pre-boot code.

Furthermore, chipset 1032 includes the I/F 1038 to couple chipset 1032 with a high-performance graphics engine, such as, graphics processing circuitry or a graphics processing unit (GPU) 1048. In other embodiments, the system 1000 may include a flexible display interface (FDI) (not shown) between the processor 1004 and/or the processor 1006 and the chipset 1032. The FDI interconnects a graphics processor core in one or more of processor 1004 and/or processor 1006 with the chipset 1032.

Additionally, accelerator 1054 and/or vision processing unit 1056 can be coupled to chipset 1032 via I/F 1038. The accelerator 1054 is representative of any type of accelerator device (e.g., a data streaming accelerator, cryptographic accelerator, cryptographic co-processor, an offload engine, etc.). One example of an accelerator 1054 is the Intel® Data Streaming Accelerator (DSA). The accelerator 1054 may be a device including circuitry to accelerate copy operations, data encryption, hash value computation, data comparison operations (including comparison of data in memory 1016 and/or memory 1018), and/or data compression. For example, the accelerator 1054 may be a USB device, PCI device, PCIe device, CXL device, UCIe device, and/or an SPI device. The accelerator 1054 can also include circuitry arranged to execute machine learning (ML) related operations (e.g., training, inference, etc.) for ML models. Generally, the accelerator 1054 may be specially designed to perform computationally intensive operations, such as hash value computations, comparison operations, cryptographic operations, and/or compression operations, in a manner that is more efficient than when performed by the processor 1004 or processor 1006. Because the load of the system 1000 may include hash value computations, comparison operations, cryptographic operations, and/or compression operations, the accelerator 1054 can greatly increase performance of the system 1000 for these operations.

The accelerator 1054 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 1054. For example, the accelerator 1054 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1054 via a non-posted write (e.g., a deferred memory write (DMWr)). One example of an instruction that atomically submits a work descriptor to the shared work queue of the accelerator 1054 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1054. The dedicated work queue may accept job submissions via commands such as the movdir64b instruction.

Various I/O devices 1060 and display 1052 couple to the bus 1072, along with a bus bridge 1058 which couples the bus 1072 to a second bus 1074 and an I/F 1040 that connects the bus 1072 with the chipset 1032. In one embodiment, the second bus 1074 may be a low pin count (LPC) bus. Various devices may couple to the second bus 1074 including, for example, a keyboard 1062, a mouse 1064 and communication devices 1066.

The system 1000 is operable to communicate with wired and wireless devices or entities via the network interface 1080 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Furthermore, an audio I/O 1068 may couple to second bus 1074. Many of the I/O devices 1060 and communication devices 1066 may reside on the system-on-chip (SoC) 1002 while the keyboard 1062 and the mouse 1064 may be add-on peripherals. In other embodiments, some or all the I/O devices 1060 and communication devices 1066 are add-on peripherals and do not reside on the system-on-chip (SoC) 1002.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes an apparatus, comprising: a network comprising a plurality of switches; and a plurality of compute cores coupled to the network, wherein a first switch of the plurality of switches is to comprise circuitry to: receive a first element of a first array and a first element of a second array; determine that the first element of the first array is less than the first element of the second array; and cause the first element of the first array to be stored as a first element of an output array.

Example 2 includes the subject matter of example 1, wherein the first switch of the plurality of switches is to comprise circuitry to: receive a second element of the first array from a first compute core of the plurality of compute cores; determine the first element of the second array is less than the first element of the first array; and cause the first element of the second array to be stored as a second element of the output array.

Example 3 includes the subject matter of example 1, wherein the first switch of the plurality of switches is to comprise circuitry to: receive, from a first compute core of the plurality of compute cores, an indication that no additional elements of the first array remain; and cause the first element of the second array to be stored as a second element of the output array.

Example 4 includes the subject matter of example 3, wherein the first switch of the plurality of switches is to comprise circuitry to: receive, from a second compute core of the plurality of compute cores, an indication that no additional elements of the second array remain; and return, to a third compute core of the plurality of compute cores, an interrupt to indicate the output array has been sorted.

Example 5 includes the subject matter of example 1, wherein the first switch of the plurality of switches is to comprise circuitry to: receive, via a second switch of the plurality of switches, a first element of a third array; determine the first element of the second array is less than the first element of the third array; and cause the first element of the second array to be stored as a second element of the output array.

Example 6 includes the subject matter of example 1, wherein the first switch determines to perform a comparison between the first element of the first array and the first element of the second array based on a configuration of the first switch.

Example 7 includes the subject matter of example 1, wherein the first switch causes the first element of the first array to be stored as the first element of the output array via a first output port of a plurality of output ports of the first switch, wherein the first output port is based on a configuration of the first switch.

Example 8 includes the subject matter of example 1, wherein the first element of the first array is received based on an instruction defined by an Instruction Set Architecture (ISA), wherein the first element of the second array is based on the instruction defined by the ISA.

Example 9 includes the subject matter of example 1, wherein a configuration of the first switch defines at least a portion of a tree to generate the output array.

Example 10 includes the subject matter of example 1, wherein the network is to comprise a Programmable and Integrated Unified Memory Architecture (PIUMA) network.

Example 11 includes a method, comprising: receiving, by a first switch of a plurality of switches of an apparatus, a first element of a first array and a first element of a second array; determining, by the first switch, that the first element of the first array is less than the first element of the second array; and causing, by the first switch, the first element of the first array to be stored as a first element of an output array.

Example 12 includes the subject matter of example 11, further comprising: receiving, by the first switch, a second element of the first array from a first compute core of the plurality of compute cores; determining, by the first switch, the first element of the second array is less than the first element of the first array; and causing, by the first switch, the first element of the second array to be stored as a second element of the output array.

Example 13 includes the subject matter of example 11, further comprising: receiving, by the first switch from a first compute core of the plurality of compute cores, an indication that no additional elements of the first array remain; and causing, by the first switch, the first element of the second array to be stored as a second element of the output array.

Example 14 includes the subject matter of example 13, further comprising: receiving, by the first switch from a second compute core of the plurality of compute cores an indication that no additional elements of the second array remain; and returning, by the first switch to a third compute core of the plurality of compute cores, an interrupt to indicate the output array has been sorted.

Example 15 includes the subject matter of example 11, further comprising: receiving, by the first switch via a second switch of the plurality of switches, a first element of a third array; determining, by the first switch, the first element of the second array is less than the first element of the third array; and causing, by the first switch, the first element of the second array to be stored as a second element of the output array.

Example 16 includes the subject matter of example 11, wherein the first switch determines to perform a comparison between the first element of the first array and the first element of the second array based on a configuration of the first switch.

Example 17 includes the subject matter of example 11, wherein the first switch causes the first element of the first array to be stored as the first element of the output array via a first output port of a plurality of output ports of the first switch, wherein the first output port is based on a configuration of the first switch.

Example 18 includes the subject matter of example 11, wherein the first element of the first array is received based on an instruction defined by an Instruction Set Architecture (ISA), wherein the first element of the second array is based on the instruction defined by the ISA.

Example 19 includes the subject matter of example 11, wherein a configuration of the first switch defines at least a portion of a tree to generate the output array.

Example 20 includes the subject matter of example 11, wherein a network of the apparatus includes the plurality of switches, wherein the network is to comprise a Programmable and Integrated Unified Memory Architecture (PIUMA) network.

Example 21 includes a non-transitory computer-readable storage medium, the computer-readable storage medium including instructions that when executed by a processor, cause the processor to: receive, by a first switch of a plurality of switches, a first element of a first array and a first element of a second array; determine, by the first switch, that the first element of the first array is less than the first element of the second array; and cause, by the first switch, the first element of the first array to be stored as a first element of an output array.

Example 22 includes the subject matter of example 21, wherein the instructions further cause the processor to: receive, by the first switch, a second element of the first array from a first compute core of a plurality of compute cores; determine, by the first switch, the first element of the second array is less than the first element of the first array; and cause, by the first switch, the first element of the second array to be stored as a second element of the output array.

Example 23 includes the subject matter of example 21, wherein the instructions further cause the processor to: receive, by the first switch from a first compute core of a plurality of compute cores, an indication that no additional elements of the first array remain; and cause, by the first switch, the first element of the second array to be stored as a second element of the output array.

Example 24 includes the subject matter of example 23, wherein the instructions further cause the processor to: receive, by the first switch from a second compute core of the plurality of compute cores, an indication that no additional elements of the second array remain; and return, by the first switch to a third compute core of the plurality of compute cores, an interrupt to indicate the output array has been sorted.

Example 25 includes the subject matter of example 21, wherein the instructions further cause the processor to: receive, via a second switch of the plurality of switches, a first element of a third array; determine the first element of the second array is less than the first element of the third array; and cause the first element of the second array to be stored as a second element of the output array.

Example 26 includes the subject matter of example 21, wherein the first switch determines to perform a comparison between the first element of the first array and the first element of the second array based on a configuration of the first switch.

Example 27 includes the subject matter of example 21, wherein the first switch causes the first element of the first array to be stored as the first element of the output array via a first output port of a plurality of output ports of the first switch, wherein the first output port is based on a configuration of the first switch.

Example 28 includes the subject matter of example 21, wherein the first element of the first array is received based on an instruction defined by an Instruction Set Architecture (ISA), wherein the first element of the second array is based on the instruction defined by the ISA.

Example 29 includes the subject matter of example 21, wherein a configuration of the first switch defines at least a portion of a tree to generate the output array.

Example 30 includes the subject matter of example 21, wherein a network defined by the plurality of switches is to comprise a Programmable and Integrated Unified Memory Architecture (PIUMA) network.

Example 31 includes an apparatus, comprising: means for receiving a first element of a first array and a first element of a second array; means for determining that the first element of the first array is less than the first element of the second array; and means for causing the first element of the first array to be stored as a first element of an output array.

Example 32 includes the subject matter of example 31, further comprising: means for receiving a second element of the first array from a first compute core of a plurality of compute cores; means for determining the first element of the second array is less than the first element of the first array; and means for causing the first element of the second array to be stored as a second element of the output array.

Example 33 includes the subject matter of example 31, further comprising: means for receiving, from a first compute core of a plurality of compute cores, an indication that no additional elements of the first array remain; and means for causing the first element of the second array to be stored as a second element of the output array.

Example 34 includes the subject matter of example 33, further comprising: means for receiving, from a second compute core of the plurality of compute cores an indication that no additional elements of the second array remain; and means for returning, to a third compute core of the plurality of compute cores, an interrupt to indicate the output array has been sorted.

Example 35 includes the subject matter of example 31, further comprising: means for receiving a first element of a third array; means for determining the first element of the second array is less than the first element of the third array; and means for causing the first element of the second array to be stored as a second element of the output array.

Example 36 includes the subject matter of example 31, wherein the first switch determines to perform a comparison between the first element of the first array and the first element of the second array based on a configuration of the first switch.

Example 37 includes the subject matter of example 31, wherein the first switch causes the first element of the first array to be stored as the first element of the output array via a first output port of a plurality of output ports of the first switch, wherein the first output port is based on a configuration of the first switch.

Example 38 includes the subject matter of example 31, wherein the first element of the first array is received based on an instruction defined by an Instruction Set Architecture (ISA), wherein the first element of the second array is based on the instruction defined by the ISA.

Example 39 includes the subject matter of example 31, wherein a configuration of the first switch defines at least a portion of a tree to generate the output array.

Example 40 includes the subject matter of example 31, wherein a network of the apparatus includes the plurality of switches, wherein the network is to comprise a Programmable and Integrated Unified Memory Architecture (PIUMA) network.

Example 41 includes a non-transitory computer-readable storage medium, the computer-readable storage medium including instructions that when executed by a processor, cause the processor to: execute a first instruction set architecture (ISA) instruction to initiate a sort operation based on a first input array of a plurality of input arrays; and execute a second ISA instruction to receive an output of the sort operation, the output to comprise a sorted array.

Example 42 includes the subject matter of example 41, wherein the first ISA instruction is to comprise a base memory address of the first input array, a size of an array element of the first input array, and a number of elements of the first input array.

Example 43 includes the subject matter of example 41, wherein the execution of the second ISA instruction returns a base memory address of the sorted array and a number of elements of the sorted array.

Example 44 includes an apparatus, comprising: an interface to memory; and a processor to execute instructions to cause the processor to: execute a first instruction set architecture (ISA) instruction to initiate a sort operation based on a first input array of a plurality of input arrays; and execute a second ISA instruction to receive an output of the sort operation, the output to comprise a sorted array.

Example 45 includes the subject matter of example 44, wherein the first ISA instruction is to comprise a base memory address of the first input array, a size of an array element of the first input array, and a number of elements of the first input array.

Example 46 includes the subject matter of example 44, wherein the execution of the second ISA instruction returns a base memory address of the sorted array and a number of elements of the sorted array.

Example 47 includes a method, comprising: executing, by a processor, a first instruction set architecture (ISA) instruction to initiate a sort operation based on a first input array of a plurality of input arrays; and executing, by the processor, a second ISA instruction to receive an output of the sort operation, the output to comprise a sorted array.

Example 48 includes the subject matter of example 47, wherein the first ISA instruction is to comprise a base memory address of the first input array, a size of an array element of the first input array, and a number of elements of the first input array.

Example 49 includes the subject matter of example 47, wherein the execution of the second ISA instruction returns a base memory address of the sorted array and a number of elements of the sorted array.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
a network comprising a plurality of switches; and
a plurality of compute cores coupled to the network,
wherein a first switch of the plurality of switches is to comprise circuitry to:
receive a first element of a first array and a first element of a second array;
determine that the first element of the first array is less than the first element of the second array; and
cause the first element of the first array to be stored as a first element of an output array.

2. The apparatus of claim 1, wherein the first switch of the plurality of switches is to comprise circuitry to:
receive a second element of the first array from a first compute core of the plurality of compute cores;
determine the first element of the second array is less than the first element of the first array; and
cause the first element of the second array to be stored as a second element of the output array.

3. The apparatus of claim 1, wherein the first switch of the plurality of switches is to comprise circuitry to:
receive, from a first compute core of the plurality of compute cores, an indication that no additional elements of the first array remain; and
cause the first element of the second array to be stored as a second element of the output array.

4. The apparatus of claim 3, wherein the first switch of the plurality of switches is to comprise circuitry to:
receive, from a second compute core of the plurality of compute cores, an indication that no additional elements of the second array remain; and
return, to a third compute core of the plurality of compute cores, an interrupt to indicate the output array has been sorted.

5. The apparatus of claim 1, wherein the first switch of the plurality of switches is to comprise circuitry to:
receive, via a second switch of the plurality of switches, a first element of a third array;
determine the first element of the second array is less than the first element of the third array; and
cause the first element of the second array to be stored as a second element of the output array.

6. The apparatus of claim 1, wherein the first switch determines to perform a comparison between the first element of the first array and the first element of the second array based on a configuration of the first switch.

7. The apparatus of claim 1, wherein the first switch causes the first element of the first array to be stored as the first element of the output array via a first output port of a plurality of output ports of the first switch, wherein the first output port is based on a configuration of the first switch.

8. The apparatus of claim 1, wherein the first element of the first array is received based on an instruction defined by an Instruction Set Architecture (ISA), wherein the first element of the second array is based on the instruction defined by the ISA.

9. The apparatus of claim 1, wherein a configuration of the first switch defines at least a portion of a tree to generate the output array.

10. The apparatus of claim 1, wherein the network is to comprise a Programmable and Integrated Unified Memory Architecture (PIUMA) network.

11. A method, comprising:
receiving, by a first switch of a plurality of switches of an apparatus, a first element of a first array and a first element of a second array;
determining, by the first switch, that the first element of the first array is less than the first element of the second array; and
causing, by the first switch, the first element of the first array to be stored as a first element of an output array.

12. The method of claim 11, further comprising:
receiving, by the first switch, a second element of the first array from a first compute core of the plurality of compute cores;
determining, by the first switch, the first element of the second array is less than the first element of the first array; and
causing, by the first switch, the first element of the second array to be stored as a second element of the output array.

13. The method of claim 11, further comprising:
receiving, by the first switch from a first compute core of the plurality of compute cores, an indication that no additional elements of the first array remain; and
causing, by the first switch, the first element of the second array to be stored as a second element of the output array.

14. The method of claim 13, further comprising:
receiving, by the first switch from a second compute core of the plurality of compute cores an indication that no additional elements of the second array remain; and
returning, by the first switch to a third compute core of the plurality of compute cores, an interrupt to indicate the output array has been sorted.

15. The method of claim 11, further comprising:
receiving, by the first switch via a second switch of the plurality of switches, a first element of a third array;
determining, by the first switch, the first element of the second array is less than the first element of the third array; and
causing, by the first switch, the first element of the second array to be stored as a second element of the output array.

16. The method of claim 11, wherein a network of the apparatus includes the plurality of switches, wherein the network is to comprise a Programmable and Integrated Unified Memory Architecture (PIUMA) network.

17. A non-transitory computer-readable storage medium, the computer-readable storage medium including instructions that when executed by a processor, cause the processor to:
receive, by a first switch of a plurality of switches, a first element of a first array and a first element of a second array;
determine, by the first switch, that the first element of the first array is less than the first element of the second array; and
cause, by the first switch, the first element of the first array to be stored as a first element of an output array.

18. The computer-readable storage medium of claim 17, wherein the instructions further cause the processor to:
receive, by the first switch, a second element of the first array from a first compute core of a plurality of compute cores;
determine, by the first switch, the first element of the second array is less than the first element of the first array; and
cause, by the first switch, the first element of the second array to be stored as a second element of the output array.

19. The computer-readable storage medium of claim 17, wherein the instructions further cause the processor to:
receive, by the first switch from a first compute core of a plurality of compute cores, an indication that no additional elements of the first array remain; and
cause, by the first switch, the first element of the second array to be stored as a second element of the output array.

20. The computer-readable storage medium of claim 19, wherein the instructions further cause the processor to:
receive, by the first switch from a second compute core of the plurality of compute cores, an indication that no additional elements of the second array remain; and
return, by the first switch to a third compute core of the plurality of compute cores, an interrupt to indicate the output array has been sorted.

21. A non-transitory computer-readable storage medium, the computer-readable storage medium including instructions that when executed by a processor, cause the processor to:
execute a first instruction set architecture (ISA) instruction to initiate a sort operation based on a first input array of a plurality of input arrays; and
execute a second ISA instruction to receive an output of the sort operation, the output to comprise a sorted array.

22. The computer-readable storage medium of claim 21, wherein the first ISA instruction is to comprise a base memory address of the first input array, a size of an array element of the first input array, and a number of elements of the first input array.

23. The computer-readable storage medium of claim 21, wherein the execution of the second ISA instruction returns a base memory address of the sorted array and a number of elements of the sorted array.
